(19) United States
(12) Patent Application Publication
(10) Pub. No.: US 2023/0154333 A1
(43) Pub. Date: May 18, 2023

(54) ROUTE PREDICTION DEVICE, ROUTE PREDICTION METHOD, AND VEHICLE CONTROL SYSTEM

(71) Applicant: Mitsubishi Electric Corporation, Tokyo (JP)

(72) Inventors: Takuji MORIMOTO, Tokyo (JP); Kyosuke Konishi, Tokyo (JP); Taku Umeda, Tokyo (JP); Yukari Goi, Tokyo (JP); Ryoma Yataka, Tokyo (JP)

(73) Assignee: Mitsubishi Electric Corporation, Tokyo (JP)

(21) Appl. No.: 17/892,590

(22) Filed: Aug. 22, 2022

(30) Foreign Application Priority Data
Nov. 12, 2021 (JP) 2021-184518

(51) Int. Cl. G08G 1/16; B60W 50/00; B60W 30/09; B60W 30/095

(52) U.S. Cl. CPC G08G 1/166; B60W 50/0097; B60W 30/09; B60W 30/0953; B60W 30/0956; B60W 2520/00; B60W 2554/4045; B60W 2552/00; B60W 2554/4041; B60W 2556/00

(57) ABSTRACT

This route prediction device includes: an information acquisition circuitry to acquire a position and a speed of an own vehicle, positions and speeds of surrounding vehicles traveling around the own vehicle, and map information around the own vehicle; a cut-in determinator to determine whether or not the surrounding vehicle will cut in onto a traveling lane of the own vehicle, on the basis of an inducing factor of inducing cut-in of another vehicle; an assumptive vehicle setting circuitry to determine a traveling position, on a road, of an assumptive vehicle assumed to influence traveling of a cut-in vehicle determined to cut in, among the surrounding vehicles, using road information obtained from the map information; and a route prediction circuitry to predict a traveling route of one of the surrounding vehicles, on the basis of the traveling position of the assumptive vehicle, and so forth.

### BACKGROUND OF THE INVENTION

### 1. Field of the Invention

The present disclosure relates to a route prediction device, a route prediction method, and a vehicle control system.

### 2. Description of the Background Art

A conventional function for predicting a behavior of another vehicle is such a function that, for a surrounding vehicle around the own vehicle, a plurality of behavior suppositions, e.g., behaviors such as straight movement, speed reduction, or lane change, are assumed to predict a behavior of the other vehicle, and with respect to these behavior suppositions, future routes are predicted and the likelihood of each behavior route is calculated on the basis of the possibility of collision with a surrounding vehicle (see, for example, Patent Document 1). In this case, the likelihood of the behavior supposition having such a route that the vehicle-to-vehicle distance to a surrounding vehicle is great, becomes high.

In such a conventional method for predicting the behavior of another vehicle, merging prediction is realized by implementing a prediction function dedicated for merging (see, for example, Patent Document 2). In this case, a prediction target vehicle is predicted to change the lane at a merging road end in accordance with the actual road situation such as presence/absence of a merging road, but in general, in merging, vehicles often complete lane change at an early stage before reaching the merging end.
Patent Document 1: Japanese Patent No. 6272566
Patent Document 2: Japanese Patent No. 6597344
Patent Document 3: Japanese Patent No. 6494121

In the function for predicting the behavior of another vehicle in Patent Document 1, the likelihood of the behavior assumed to have such a route that the vehicle-to-vehicle distance to a surrounding vehicle is great, becomes high. That is, a plurality of behaviors (straight movement, speed reduction, lane change) are assumed for a surrounding vehicle, future routes are predicted for the respective assumed behaviors, and the likelihood of each behavior route is calculated on the basis of the possibility of collision with the surrounding vehicle. Thus, the likelihood of the above assumed behavior becomes high.

Patent Document 2 describes, regarding merging prediction, a function of predicting to which of the front and rear sides of the own vehicle a merging vehicle will cut in. However, this other-vehicle behavior prediction function is specialized for a merging road and thus cannot be commonly used with the other-vehicle behavior prediction function for a case where another vehicle is traveling on the same main lane as the own vehicle, for example. Therefore, it is necessary to implement a dedicated function, in other words, a dedicated program.

Patent Document 3 describes a modification in which, when a specific vehicle used for prediction is not present on a road, the vanishing point of a merging road is used instead of the specific vehicle. However, when the specific vehicle is present, prediction in consideration of the vanishing point of a merging road cannot be performed, and therefore the modification in Patent Document 3 cannot be used universally in merging prediction. That is, in merging prediction, it is necessary to implement the prediction function specialized for merging.

Therefore, it is necessary to implement different functions (programs) for respective actual road situations, thus causing a problem that the program size or the consumed memory amount increases.

### SUMMARY OF THE INVENTION

The present disclosure has been made to solve the above problem and an object of the present disclosure is to provide a route prediction device that places an assumptive vehicle in accordance with an actual road situation so as to enable the same prediction function to be used irrespective of the actual road situation, thus reducing the program size or the consumed memory amount.

A route prediction device according to the present disclosure includes: an information acquisition circuitry for acquiring a position and a speed of an own vehicle, positions and speeds of surrounding vehicles traveling around the own vehicle, and map information around the own vehicle; a cut-in determinator for determining whether or not the surrounding vehicle will cut in onto a traveling lane of the own vehicle, on the basis of an inducing factor of inducing cut-in of another vehicle; an assumptive vehicle setting circuitry for determining a traveling position, on a road, of an assumptive vehicle assumed to influence traveling of a cut-in vehicle determined to cut in, among the surrounding vehicles, using road information obtained from the map information; and a route prediction circuitry for predicting a traveling route of one of the surrounding vehicles, on the basis of the road information, the traveling position of the own vehicle, and the traveling position of the assumptive vehicle with respect to the traveling position of the one surrounding vehicle.

The route prediction device according to the present disclosure places an assumptive vehicle in accordance with an actual road situation so as to enable the same prediction function to be used irrespective of the actual road situation, thus reducing the program size or the consumed memory amount.

### BRIEF DESCRIPTION OF THE DRAWINGS

FIG. 1 shows an example of the configuration of a route prediction device according to the first embodiment of the present disclosure;

FIG. 2 illustrates an example of an assumptive vehicle setting circuitry of the route prediction device according to the first embodiment;

FIG. 3 is a flowchart illustrating operation of the route prediction device according to the first embodiment;

FIGS. 4A and 4B illustrate Example 1 regarding the assumptive vehicle setting circuitry of the route prediction device according to the first embodiment;

FIG. 5 illustrates Example 2 regarding the assumptive vehicle setting circuitry of the route prediction device according to the first embodiment;

FIGS. 6A and 6B illustrate Example 3 regarding the assumptive vehicle setting circuitry of the route prediction device according to the first embodiment;

FIGS. 7A and 7B illustrate Example 4 regarding the assumptive vehicle setting circuitry of the route prediction device according to the first embodiment;

FIG. 8 illustrates Example 5 regarding the assumptive vehicle setting circuitry of the route prediction device according to the first embodiment;

FIGS. 9A and 9B illustrate Example 6 regarding the assumptive vehicle setting circuitry of the route prediction device according to the first embodiment;

FIG. 10 shows an example of the configuration of a route prediction device according to the second embodiment of the present disclosure;

FIGS. 11A to 11D illustrate a likelihood calculator in a route prediction circuitry of the route prediction device according to the second embodiment;

FIG. 12 is a flowchart illustrating operation of the route prediction device according to the second embodiment;

FIG. 13 shows an example of a vehicle control system provided with the route prediction device according to the first or second embodiment; and

FIG. 14 shows an example of hardware provided to each device composing the route prediction devices according to the first and second embodiments.

### DETAILED DESCRIPTION OF THE PREFERRED EMBODIMENTS OF THE INVENTION

The present disclosure relates to a route prediction device for predicting a traveling route of a vehicle. Specifically, this route prediction device is characterized in that an assumptive vehicle is placed in accordance with an actual road situation such as merging or decrease in the number of lanes, whereby, using a normal other-vehicle behavior prediction function not depending on the actual road situation, prediction of the other-vehicle behavior depending on the actual road situation is achieved. Hereinafter, the route prediction device according to the first embodiment of the present disclosure will be described in order with reference to the drawings.

### First Embodiment

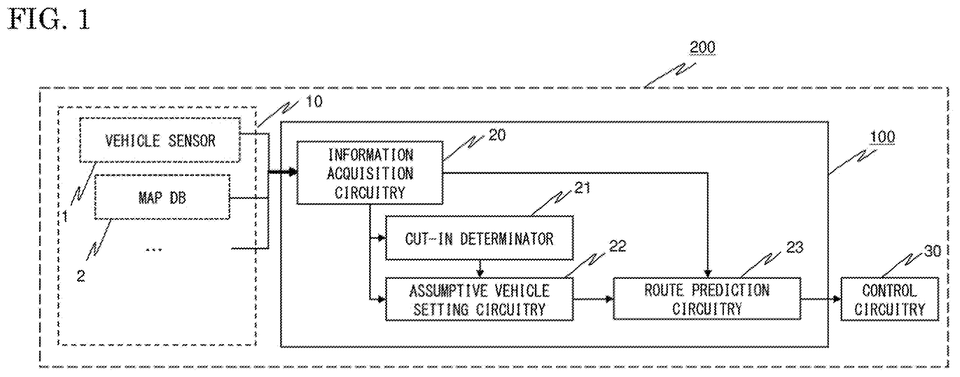

FIG. 1 is a block diagram showing an example of the configuration of a route prediction device 100 according to the first embodiment.

The route prediction device 100 of the first embodiment receives own-vehicle surrounding information acquired by a vehicle sensor 1, such as a radar or a vehicle-speed sensor, of an information providing device 10 provided to a vehicle 200, and outputs a result of prediction for a traveling route of a surrounding vehicle around the own vehicle.

The output of the route prediction device 100 can be used for vehicle control or safety indication. For example, in a case where it is predicted with a high probability that a surrounding vehicle around the own vehicle will cut in to the front side on the traveling route of the own vehicle, it is possible to perform control in association with traveling of the own vehicle, e.g., perform control for reducing the speed of the own vehicle or indicate an alarm on an on-vehicle display or the like.

In FIG. 1, for example, outside the route prediction device 100, the information providing device 10 which is composed of the vehicle sensor 1, a map database 2 (hereinafter, may be referred to as a map DB), and the like and provides own-vehicle surrounding information, is disposed. From the information providing device 10, the own-vehicle surrounding information is inputted to the route prediction device 100.

On the other hand, the route prediction device 100 takes the own-vehicle surrounding information provided from the information providing device 10, by an information acquisition circuitry 20, and on the basis of the own-vehicle surrounding information taken by the information acquisition circuitry 20, predicts a traveling route of a surrounding vehicle around the own vehicle, using a cut-in determinator 21, an assumptive vehicle setting circuitry 22, a route prediction circuitry 23, and the like provided to the route prediction device 100. Then, the route prediction device 100 outputs the prediction result to a control circuitry 30 provided outside the route prediction device 100. Hereinafter, the above components of the route prediction device 100 will be specifically described in order.

First, the information acquisition circuitry 20 will be described. The information acquisition circuitry 20 acquires the position and speed of the own vehicle, the position and speed of a surrounding vehicle, and map information around the own vehicle from devices such as a millimeter-wave radar, a laser radar, an optical camera, a vehicle speed sensor, a GPS locator for outputting own vehicle coordinates, and a map database for outputting road information.

The information acquisition circuitry 20 may pass data acquired from each of the above devices, directly to a subsequent process, or may integrate output results of a plurality of devices and pass the integrated result to a subsequent process. For example, the information acquisition circuitry 20 may perform processing such as performing matching of the surrounding vehicle position with road lane shape data acquired from the map database in order to improve accuracy of cut-in determination to be performed later.

Next, the cut-in determinator 21 will be described. The cut-in determinator 21 determines, for all the surrounding vehicles, whether or not it is assumed that the surrounding vehicle cuts in onto the own vehicle traveling lane due to a cut-in inducing factor of a road, using at least the own vehicle position, the surrounding vehicle position, and information outputted from the information acquisition circuitry.

Here, the cut-in inducing factor refers to an actual road situation such as merging or decrease in the number of lanes. In addition, cut-in refers to a behavior of a surrounding vehicle moving onto the traveling lane of the own vehicle and is not limited to cut-in to a position just in front of the own vehicle.

One example of the above cut-in inducing factor is merging. For example, in a case where the own vehicle is traveling on the main road near a merging point and a surrounding vehicle is traveling on a merging road, it is assumed that the surrounding vehicle will cut in onto the traveling lane of the own vehicle before the merging end. Another example of the cut-in inducing factor is lane change due to lane restriction information or decrease in the number of lanes.

In the following description, a case where the cut-in inducing factor is merging is adopted as an example.

Next, the assumptive vehicle setting circuitry will be described.

Here, for a cut-in vehicle (hereinafter, may be referred to as a prediction target vehicle) assumed to cut in onto a traveling lane of the own vehicle, an assumptive vehicle is set on the basis of the positional relationship between the cut-in vehicle and the road. Here, the assumptive vehicle means a vehicle that influences the cut-in vehicle in a route prediction process for the cut-in vehicle, and can be set at any position from the prediction target vehicle position to a cut-in end (in a merging road, a merging end).

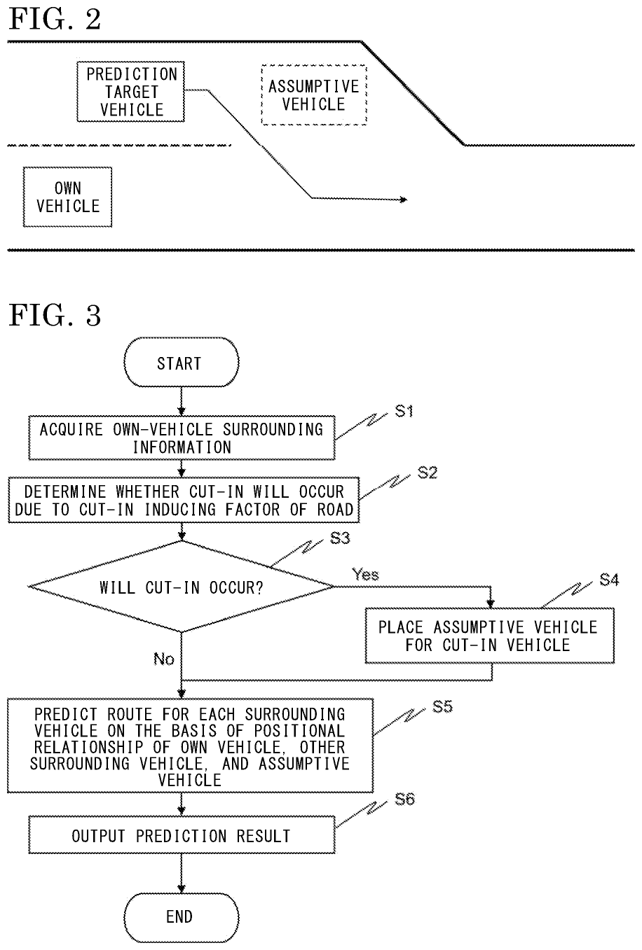

As an example of the setting method, an assumptive vehicle stopping at the center between the cut-in vehicle and the merging road end frontward of the cut-in vehicle can be assumed (see FIG. 2). Other examples of the setting method will be described in detail later.

Lastly, the route prediction circuitry will be described.

The route prediction circuitry predicts, for a plurality of surrounding vehicles around the own vehicle, a traveling route of each surrounding vehicle on the basis of at least the positional relationship among the own vehicle, other vehicles as the surrounding vehicles, the above assumptive vehicle, and the road. In addition, at this time, more advanced prediction may be performed using the speeds or accelerations of the own vehicle and the surrounding vehicles.

Here, as the prediction method, a route prediction method in accordance with a general traveling rule can be used without the need of being specialized for merging.

As an example of the route prediction method, here, prediction is performed in accordance with a rule that a surrounding vehicle travels at an equal speed in accordance with the actual road situation and changes the lane to the right lane when being likely to collide with a front vehicle.

Next, operation of the route prediction device 100 will be described with reference to FIG. 3.

FIG. 3 is a flowchart illustrating operation of the route prediction device 100.

First, the 20 acquires own-vehicle surrounding information (step S1).

Next, in order to perform determination for cut-in due to a cut-in inducing factor of a road on which the own vehicle is traveling, the acquired own-vehicle surrounding information is taken into the cut-in determinator 21 (step S2).

Next, the cut-in determinator 21 determines whether or not cut-in will occur (step S3).

As a result, if it is predicted that cut-in will occur, the assumptive vehicle setting circuitry 22 sets an assumptive vehicle for the cut-in vehicle (vehicle predicted to cut in) (step S4), and then the process proceeds to the next step (step S5). On the other hand, if it is predicted that cut-in will not occur, the process directly proceeds to the next step (step S5).

Next, for each of surrounding vehicles around the own vehicle (each of a plurality of surrounding vehicles located around the own vehicle), the route prediction circuitry 23 predicts a route corresponding to each surrounding vehicle around the own vehicle on the basis of the positional relationship between the own vehicle and the surrounding vehicle (step S5).

Next, the prediction results for the respective surrounding vehicles predicted by the route prediction circuitry 23 are outputted to the control circuitry 30 (step S6).

Here, an assumptive vehicle is set per one cut-in vehicle. However, in a case where a plurality of vehicles on the same merging road are predicted to cut in, one assumptive vehicle may be set for the plurality of vehicles.

Hereinafter, with respect to the first embodiment described above, in particular, examples regarding the assumptive vehicle setting circuitry will be described in order, using a plurality of specific cases.

### Example 1

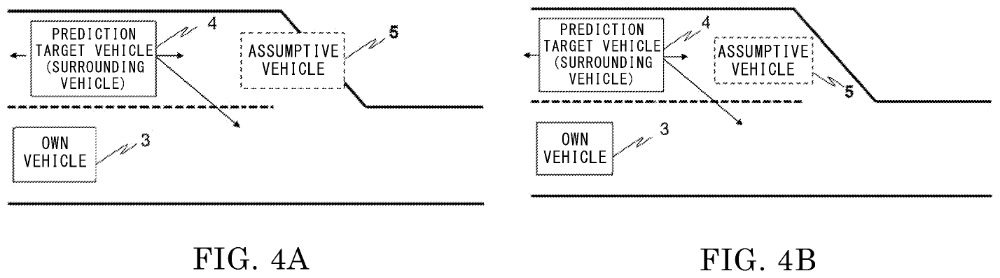

The assumptive vehicle setting circuitry will be described below in Example 1 which is a first specific case (see FIGS. 4A and 4B). Example 1 is an example in which, in particular, an assumptive vehicle 5 is set between a surrounding vehicle 4 around the own vehicle 3 and a causing point of a cut-in inducing factor, such as a merging road end. FIG. 4A shows a case where it is safe to move straight and therefore a lane change likelihood is low. FIG. 4B shows a case where the possibility of occurrence of an accident is high when the surrounding vehicle 4 moves straight, and therefore a lane change likelihood is high.

In this example, if the assumptive vehicle 5 is set at the merging road end, a likelihood in which lane change is assumed to be performed does not become high until the surrounding vehicle 4 comes close to the merging road end. Therefore, the assumptive vehicle 5 can be set at any position between the merging road end and the surrounding vehicle 4 which is a prediction target vehicle. Collision determination between the assumptive vehicle 5 and every vehicle may be performed, or collision determination of the assumptive vehicle 5 may not be performed for vehicles other than cut-in vehicles, so as not to influence route prediction for other vehicles.

As described above, in Example 1, an assumptive vehicle is set between a vehicle and a merging road end (cut-in inducing factor), whereby it becomes possible to predict a surrounding vehicle behavior of performing lane change or speed reduction for avoiding the assumptive vehicle.

### Example 2

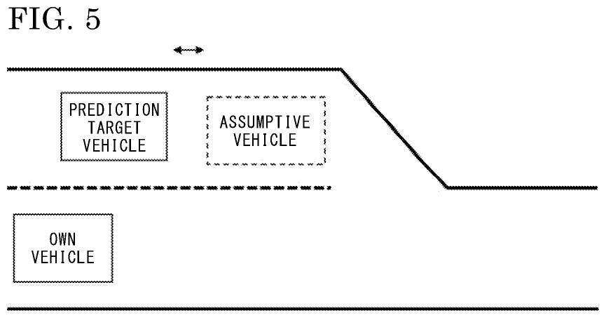

The assumptive vehicle setting circuitry will be described below in Example 2 which is a second specific case (see FIG. 5). Example 2 is an example in which, in particular, the traveling position of an assumptive vehicle is set to be changed to a frontward position distant by a certain distance from the traveling position of a surrounding vehicle (see FIG. 5).

In this example, in particular, in a case where the merging road is long, if the assumptive vehicle is too far, the possibility of collision between the prediction target vehicle and the assumptive vehicle is determined to be low, so that a likelihood of lane change becomes low.

Therefore, in this example, the assumptive vehicle is set at a frontward position distant by a certain distance from the prediction target vehicle, whereby the lane change likelihood can be kept high.

### Example 3

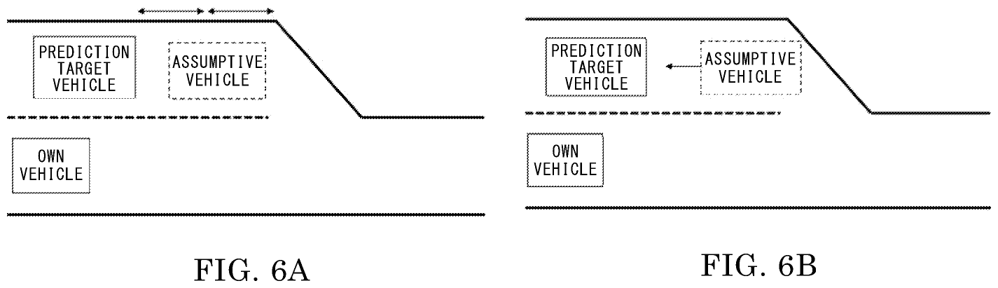

The assumptive vehicle setting circuitry will be described below in Example 3 which is a third specific case (see FIGS. 6A and 6B). Example 3 is an example in which, in particular, an assumptive vehicle is set so that the assumptive vehicle becomes closer to the surrounding vehicle as the traveling position of the surrounding vehicle and the position at a causing point of the cut-in inducing factor become closer to each other.

This example is an example in which, in particular, the driver is a human, and in this case, the driver understands that, in merging, if the vehicle stops at the merging road end, it becomes difficult to merge after that, and therefore, when coming close to the merging road end, the driver might perform lane change even if the collision possibility is high to a certain extent. That is, an assumptive vehicle position is dynamically changed in accordance with the positions of the prediction target vehicle and the merging road end (see FIG. 6A; FIG. 6A shows a case where the assumptive vehicle position is set so as to be the middle position between the traveling position of the prediction target vehicle and the merging road end), or the assumptive vehicle is set at a speed slower than the prediction target vehicle (see FIG. 6B; the difference from FIG. 6A is due to tuning property).

In this example, the position or speed of the assumptive vehicle is set so that the lane change likelihood becomes higher as approaching the merging road end. Thus, it becomes possible to achieve prediction in accordance with the above way of thinking of the driver.

### Example 4

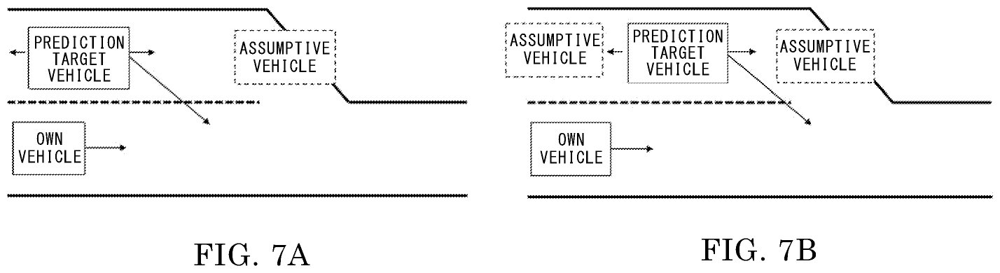

The assumptive vehicle setting circuitry will be described below in Example 4 which is a fourth specific case (see FIGS. 7A and 7B). Example 4 is an example in which, in particular, an assumptive vehicle is set at a position rearward of the surrounding vehicle.

In this example, in particular, depending on the positional relationship, the likelihood in which speed reduction of the prediction target vehicle is assumed becomes higher than the likelihood in which lane change thereof is assumed. In a case where the driver is a human, since, if the vehicle slows down or stops on the merging road, it becomes difficult to perform a merging behavior after that, the driver might think of desiring to change the lane without reducing the speed as far as possible on the merging road. FIG. 7A shows a case where it is safest to reduce the speed and therefore the likelihood thereof becomes high, and FIG. 7B shows a case where an assumptive vehicle is set rearward and thereby the likelihood of speed reduction is lowered.

In this example, the assumptive vehicle is set rearward on the merging road, whereby the way of thinking of the driver is reproduced and thus the likelihood in which speed reduction is assumed can be adjusted to be low.

### Example 5

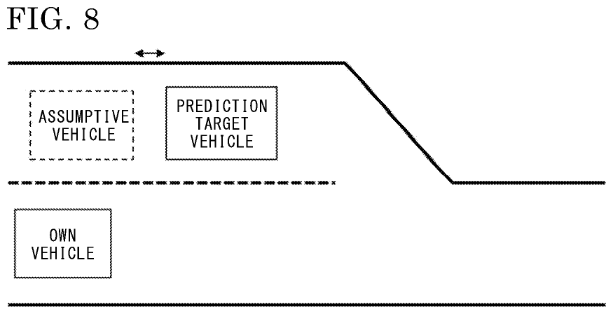

The assumptive vehicle setting circuitry will be described below in Example 5 which is a fifth specific case (see FIG. 8). Example 5 is an example in which, in particular, the assumptive vehicle position is set to a rearward position distant by a certain distance from the surrounding vehicle.

In this example, in particular, the assumptive vehicle is set at a certain position rearward of the prediction target vehicle, whereby the likelihood of speed reduction can be kept low.

### Example 6

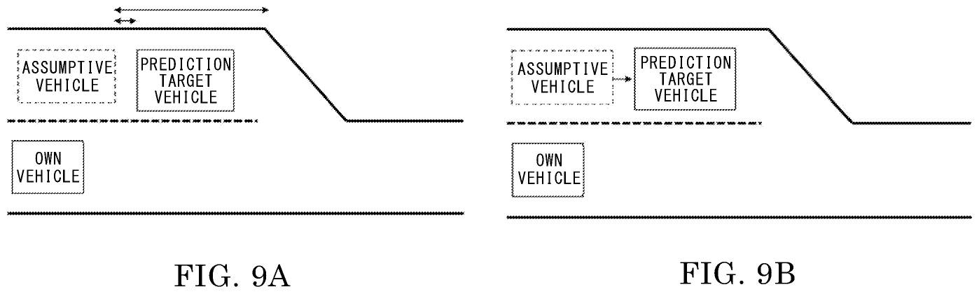

The assumptive vehicle setting circuitry will be described below in Example 6 which is a sixth specific case (see FIGS. 9A and 9B). Example 6 is an example in which, in particular, an assumptive vehicle is set so that the assumptive vehicle becomes closer to the surrounding vehicle as the traveling position of the surrounding vehicle and the position at a causing point of the cut-in inducing factor become closer to each other.

This example is an example in which, in particular, a human driver understands that, in merging, if the vehicle stops at the merging road end, it becomes difficult to merge after that, and therefore, when coming close to the merging road end, the human driver might perform lane change even if the collision possibility is high to a certain extent.

By a method A (see FIG. 9A) and a method B (see FIG. 9B) shown below, the position or speed of the assumptive vehicle is set so that the lane change likelihood becomes higher as approaching the merging road end, whereby it becomes possible to achieve prediction in accordance with the above way of thinking of the driver. That is, in the method A, the assumptive vehicle position is dynamically changed in accordance with the positions of the prediction target vehicle and the merging road end (e.g., distance to merging road end×0.1). On the other hand, in the method B, the assumptive vehicle is set to have a speed in a direction to approach the prediction target vehicle.

Since the route prediction device according to the first embodiment is configured as described above, it becomes possible to predict such a behavior that a prediction target vehicle performs lane change before reaching a merging road end. In addition, it becomes possible to perform route prediction in merging, using the route prediction circuitry implemented with no relation to merging.

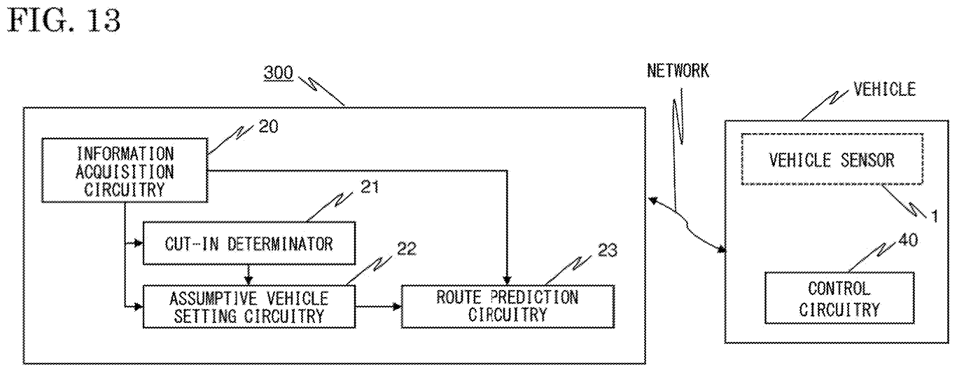

It is noted that the configuration of the route prediction device according to the first embodiment shown in FIG. 1 is assumed to be provided to a vehicle, but a configuration as a vehicle control system may be adopted. For example, prediction may be performed by a vehicle control system 300 that has the route prediction device and is connected via a network to a vehicle provided with a vehicle speed sensor and a control circuitry 40 (see FIG. 13).

### Second Embodiment

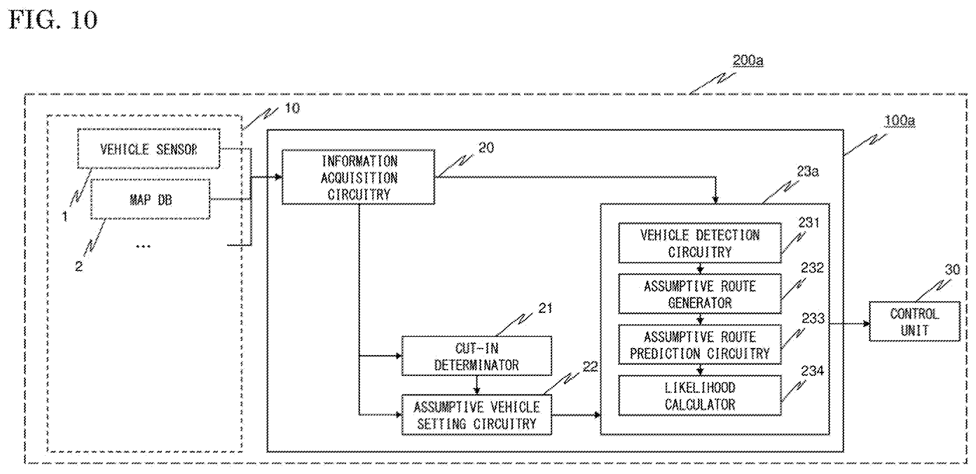

Hereinafter, a route prediction device according to the second embodiment of the present disclosure will be described in order with reference to FIG. 10. Here, in particular, differences from the route prediction device of the first embodiment will be mainly described.

As shown in FIG. 10, in a route prediction device 100a provided to a vehicle 200a in the second embodiment, a route prediction circuitry 23a further includes a vehicle detection circuitry 231, an assumptive route generator 232, an assumptive route prediction circuitry 233, and a likelihood calculator 234. The information acquisition circuitry, the cut-in determinator, and the assumptive vehicle setting circuitry are the same as those in the first embodiment, and therefore the description thereof is omitted here.

First, the vehicle detection circuitry 231 of the route prediction circuitry 23a will be described.

The vehicle detection circuitry 231 detects, among surrounding vehicles, a surrounding vehicle having a possibility of collision with any of the own vehicle, another surrounding vehicle, or an assumptive vehicle. At this time, the assumptive vehicle influences only the possibility of collision of a specific vehicle, as described above.

The collision possibility may be obtained through simple calculation of determining whether the distance between vehicles is within a threshold, or may be calculated from a future positional relationship among vehicles calculated from states such as positions, speeds, and accelerations of the vehicles.

Next, the assumptive route generator 232 of the route prediction circuitry 23a will be described.

The assumptive route generator 232 determines one or more assumed behaviors for avoiding collision, for the vehicle having a collision possibility, detected by the vehicle detection circuitry 231 (this vehicle is also included as a prediction target vehicle; this prediction target vehicle may be referred to as one of surrounding vehicles). Examples of the assumed behaviors include keeping the speed, reducing the speed, and changing the lane.

Next, with reference to FIG. 10, the assumptive route prediction circuitry 233 of the route prediction circuitry 23a will be described.

The assumptive route prediction circuitry 233 predicts, for the determined behavior assumptions, a route in a case where the prediction target vehicle selects each assumption.

Here, the prediction method may be any method. For example, the prediction may be performed in accordance with the following rule.

(a) Keep speed: keep the present speed and perform constant speed movement in the lane direction.

(b) Reduce speed: perform a constant acceleration movement in the lane direction at a certain deceleration.

(c) Change lane: perform a lane change behavior to the left or right lane at a constant speed.

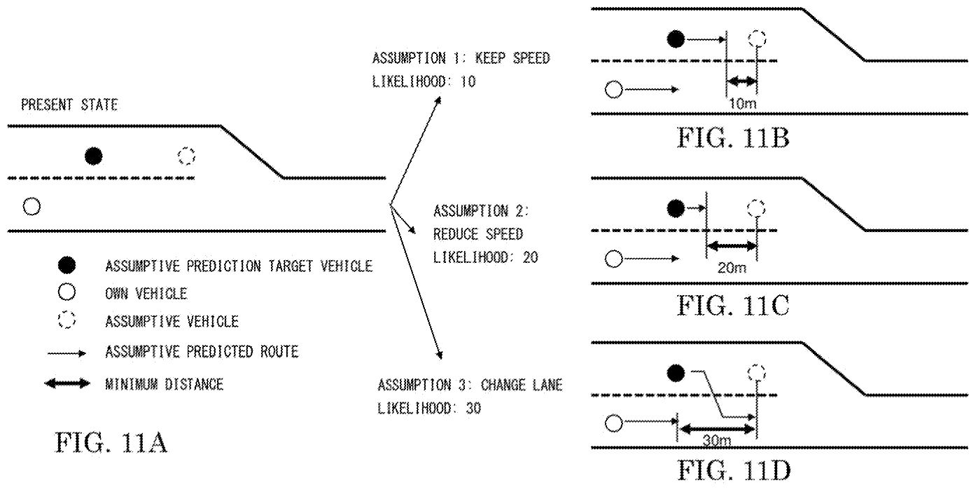

Lastly, the likelihood calculator 234 of the route prediction circuitry 23a will be described with reference to FIG. 11. The likelihood calculator 234 calculates a likelihood indicating a probability that each assumed behavior occurs, on the basis of the assumptive predicted routes (indicated by rightward arrows in FIG. 11).

As an example of calculation of the likelihood, the minimum distance in the lane direction between a future position of the prediction target vehicle on the assumptive predicted route after a certain time and a future position of another vehicle (own vehicle, other vehicle, assumptive vehicle) on the predicted route after the certain time, is calculated, and the likelihood is calculated from the distance. Regarding the other vehicle, the predicted route may be determined under the assumption that the other vehicle performs a lane keeping behavior, or as with the prediction target vehicle, predicted routes corresponding to one or more assumptions may be calculated and the minimum distances may be calculated for all combinations.

Besides, the minimum proximate distance on the route may be used as the likelihood, a value normalized so that the sum of likelihoods becomes 1 may be used as the likelihood, or the likelihood may be weighted for each assumption, for example.

To sum up the above, the route prediction circuitry 23a outputs the assumed behavior, the assumptive route, and the likelihood. At this time, the assumptive routes and the likelihoods are outputted for all the assumed behaviors, or only information regarding the assumed behavior for which the likelihood is maximized may be outputted.

Next, a method for setting an assumptive vehicle in the second embodiment will be described in detail, using examples. Here, as a first example, a case of setting an assumptive vehicle between a surrounding vehicle and a cut-in end will be specifically described (see FIGS. 4A, 4B, FIG. 5, FIGS. 6A, 6B, and FIGS. 11A, 11B, 11C, 11D).

The reason for setting an assumptive vehicle between a surrounding vehicle and a cut-in end is that setting an assumptive vehicle between a surrounding vehicle and a cut-in end makes it possible to predict a surrounding vehicle behavior of performing lane change or speed reduction for avoiding the assumptive vehicle. In this case, the likelihood of a (assumed) behavior of lane change becomes higher as the assumptive vehicle is set to be closer.

Here, the assumptive vehicle may be set at a fixed position such as 10 m from the merging road end (see FIG. 11B, FIG. 4B), or may be set at a fixed position such as 20 m frontward from the prediction target vehicle (see FIG. 11C, FIG. 5). The position as a setting reference is not limited to the merging road end, and for example, a start point of a taper portion where the merging road gradually shifts to the main lane may be used as a reference. At this time, in a case where the prediction target vehicle has overtaken the assumptive vehicle set position, the assumptive vehicle may be set by another method.

The assumptive vehicle may be set using a function of a distance between the prediction target vehicle and the merging end, or the assumptive vehicle traveling at a speed slower than the prediction target vehicle may be set, so that the assumptive vehicle and the prediction target vehicle become closer to each other as approaching the merging end (see FIG. 6A, FIG. 6B).

The above-described methods may be used so as to be switched in accordance with the distance between the prediction target vehicle and the merging road end.

A plurality of assumptive vehicles may be set for one prediction target vehicle. For example, assumptive vehicles may be set at the taper portion start point and the merging road end, whereby, for example, if the prediction target vehicle is far from the merging road end, route prediction may be performed on the basis of the positional relationship between the prediction target vehicle and the taper portion, and if the prediction target vehicle has entered the taper portion, route prediction may performed on the basis of the positional relationship between the prediction target vehicle and the merging road end. Thus, it becomes possible to perform flexible route prediction.

Next, as a second example, a case of setting an assumptive vehicle rearward of a surrounding vehicle will be described in detail.

By placing an assumptive vehicle rearward of a prediction target vehicle, it becomes possible to perform prediction in view of the driver's way of thinking of desiring to merge without reducing the speed or stopping the vehicle as far as possible (see FIG. 7A, FIG. 7B).

The assumptive vehicle may be set at a fixed position such as 20 m rearward from the prediction target vehicle (see FIG. 8). The assumptive vehicle placement position may be set using a function of a distance between the prediction target vehicle and the merging end, or the assumptive vehicle traveling at a speed faster than the prediction target vehicle may be set, so that the assumptive vehicle and the prediction target vehicle become closer to each other as approaching the merging end (see FIG. 9A, FIG. 9B). The above-described methods may be used so as to be switched in accordance with the distance between the prediction target vehicle and the merging road end.

Further, different assumptive vehicles may be respectively set on the front and rear sides of the surrounding vehicle.

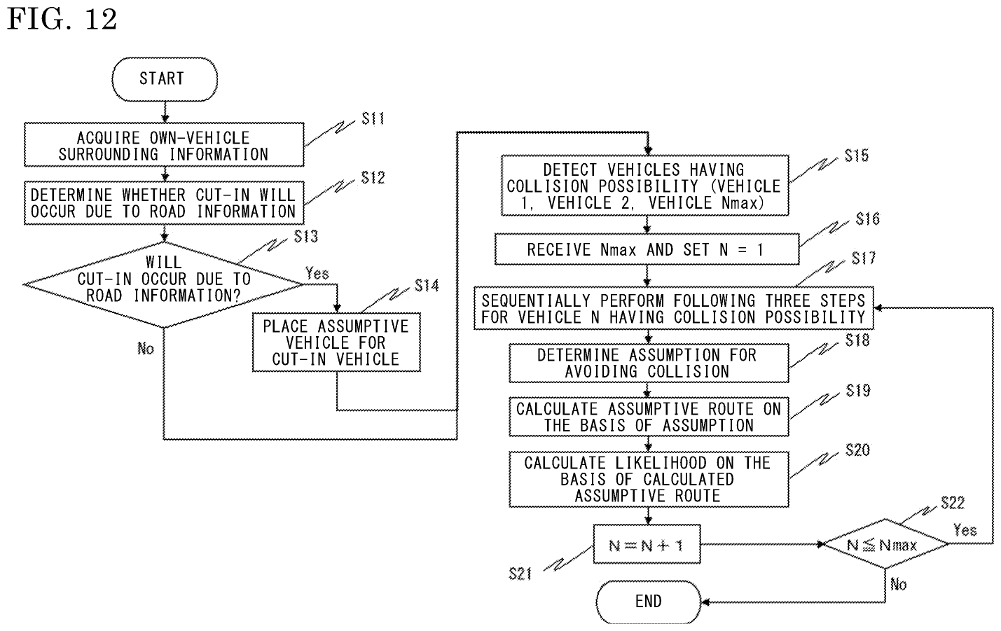

Next, operation of the route prediction device 100a will be described with reference to FIG. 12.

FIG. 12 is a flowchart illustrating operation of the route prediction device 100a.

First, the information acquisition circuitry 20 acquires own-vehicle surrounding information (step S11).

Next, in order to perform determination for cut-in due to road information of a road on which the own vehicle is traveling, the acquired own-vehicle surrounding information is taken into the cut-in determinator 21 (step S12).

Next, the cut-in determinator 21 determines whether or not cut-in due to the road information will occur (step S13). As a result, if it is predicted that cut-in will occur, the assumptive vehicle setting circuitry 22 sets an assumptive vehicle for the cut-in vehicle (vehicle predicted to cut in; this vehicle may be referred to as a prediction target vehicle) (step S14), and information that the assumptive vehicle setting circuitry has is outputted. On the other hand, if it is predicted that cut-in will not occur, information that the assumptive vehicle setting circuitry has is directly outputted.

Next, vehicles having a collision possibility (these vehicles are defined as vehicle 1, vehicle 2, . . . , vehicle Nₘₐₓ) are detected (step S15).

Next, the value of the above Nₘₐₓ is received and a parameter N is set as N=1 (step S16).

Next, for every vehicle having a collision possibility, the following three steps are sequentially performed (step S17).

(1) Determine an assumption for avoiding collision (step S18).

(2) Calculate a predicted route on the basis of the assumption (step S19).

(3) Calculate a likelihood on the basis of the calculated predicted route (step S20).

Next, a new parameter N is calculated as N=N+1 (step S21).

The new N is compared with Nₘₐₓ, and whether or not N is equal to or smaller than Nₘₐₓ is determined (step S22). If N is equal to or smaller than Nₘₐₓ, the process returns to the above step S17 to continue the processing. If N is greater than Nₘₐₓ, the process is ended.

Since the route prediction device according to the second embodiment is configured as described above, it becomes possible to predict such a behavior that a prediction target vehicle performs lane change before reaching a merging road end. In addition, it becomes possible to perform route prediction in merging, using the route prediction circuitry implemented with no relation to merging. In addition, an assumptive vehicle can be set in accordance with the actual road situation (merging or decrease in the number of lanes), and thus prediction in accordance with the actual road situation can be performed even with almost the same configuration as the conventional device. In addition, since a dedicated function specialized for merging need not be implemented, implementation efficiency is improved. Further, it is possible to reproduce a driver's natural motivation “to change the lane before the merging end” by adjusting the position or speed of the assumptive vehicle.

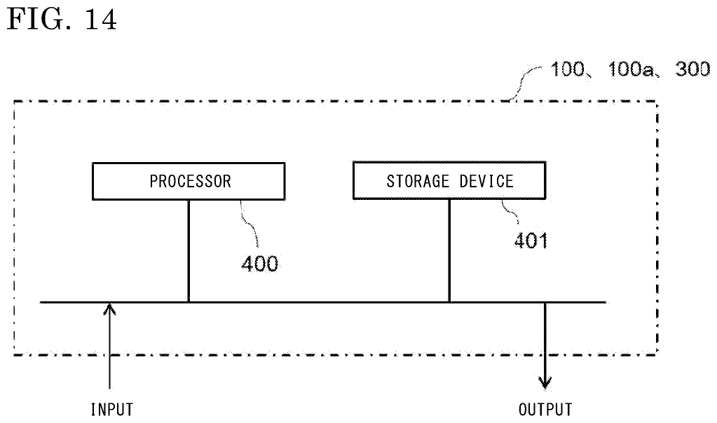

The route prediction devices 100, 100a and the vehicle control system 300 each include a processor 400 and a storage device 401 as shown in FIG. 14 which shows an example of hardware thereof. The storage device is provided with a volatile storage device such as a random access memory and a nonvolatile auxiliary storage device such as a flash memory, although not shown. Instead of a flash memory, an auxiliary storage device of a hard disk may be provided. The processor 400 executes a program inputted from the storage device 401. In this case, the program is inputted from the auxiliary storage device to the processor 400 via the volatile storage device. The processor 400 may output data such as a calculation result to the volatile storage device of the storage device 401, or may store such data into the auxiliary storage device via the volatile storage device.

Although the disclosure is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

1 vehicle sensor
2 map database (map DB)
3 own vehicle
4 surrounding vehicle
5 assumptive vehicle
10 information providing device
20 information acquisition circuitry
21 cut-in determinator
22 assumptive vehicle setting circuitry
23, 23a route prediction circuitry
30, 40 control circuitry
100, 100a route prediction device
200, 200a vehicle
231 vehicle detection circuitry
232 assumptive route generator
233 assumptive route prediction circuitry
234 likelihood calculator
300 vehicle control system
400 processor
401 storage device

What is claimed is:

1. A route prediction device comprising:
an information acquisition circuitry to acquire a position and a speed of an own vehicle, positions and speeds of surrounding vehicles traveling around the own vehicle, and map information around the own vehicle;
a cut-in determinator to determine whether or not the surrounding vehicle will cut in onto a traveling lane of the own vehicle, on the basis of an inducing factor of inducing cut-in of another vehicle;
an assumptive vehicle setting circuitry to determine a traveling position, on a road, of an assumptive vehicle assumed to influence traveling of a cut-in vehicle determined to cut in, among the surrounding vehicles, using road information obtained from the map information; and
a route prediction circuitry to predict a traveling route of one of the surrounding vehicles, on the basis of the road information, the traveling position of the own vehicle, and the traveling position of the assumptive vehicle with respect to the traveling position of the one surrounding vehicle.

2. The route prediction device according to claim 1, wherein
the assumptive vehicle setting circuitry to determine the traveling position of the assumptive vehicle on the road, using the road information obtained from the map information, and traveling information including at least a position, about the cut-in vehicle determined to cut in, among the surrounding vehicles.

3. The route prediction device according to claim 1, wherein
the route prediction circuitry includes
a vehicle detection circuitry to detect one of the surrounding vehicles that has a possibility of collision with any of the own vehicle, another of the surrounding vehicles, or the assumptive vehicle,
an assumptive route generator to generate a provisional traveling route for avoiding collision of the one surrounding vehicle detected by the vehicle detection circuitry,
an assumptive route prediction circuitry to predict an assumptive route with respect to the provisional traveling route, and
a likelihood calculator to calculate a likelihood indicating a probability that the provisional traveling route occurs, on the basis of the assumptive route predicted by the assumptive route prediction circuitry.

4. The route prediction device according to claim 1, wherein
the assumptive vehicle setting circuitry sets the traveling position of the assumptive vehicle between the traveling position of the surrounding vehicle, and a position at a causing point of a cut-in inducing factor, including a merging road end.

5. The route prediction device according to claim 4, wherein
the assumptive vehicle setting circuitry changes the traveling position of the assumptive vehicle to a frontward position distant by a certain distance from the traveling position of the surrounding vehicle.

6. The route prediction device according to claim 4, wherein
the assumptive vehicle setting circuitry places the assumptive vehicle so that the assumptive vehicle becomes closer to the surrounding vehicle in accordance with an extent to which the surrounding vehicle and the inducing factor become closer to each other.

7. The route prediction device according to claim 1, wherein
the assumptive vehicle setting circuitry places the assumptive vehicle rearward of the surrounding vehicle.

8. The route prediction device according to claim 7, wherein
the assumptive vehicle setting circuitry sets the position of the assumptive vehicle so as to be changed to a rearward position distant by a certain distance from the surrounding vehicle.

9. The route prediction device according to claim 7, wherein
the assumptive vehicle setting circuitry places the assumptive vehicle so that the assumptive vehicle becomes closer to the surrounding vehicle in accordance with an extent to which the surrounding vehicle and the inducing factor become closer to each other.

10. A route prediction method for predicting a vehicle traveling route using the route prediction device according to claim 1, the method comprising:
acquiring own-vehicle surrounding information by the information acquisition circuitry;
taking the acquired own-vehicle surrounding information into the cut-in determinator in order to perform determination for cut-in due to a cut-in inducing factor of inducing cut-in of another vehicle onto a road on which the own vehicle is traveling;
determining whether or not cut-in will occur, by the cut-in determinator; and
for a plurality of surrounding vehicles, predicting a route corresponding to each surrounding vehicle by the route prediction circuitry on the basis of a positional relationship between the own vehicle and each surrounding vehicle.

11. A vehicle control system comprising the route prediction device according to claim 1, the vehicle control system being connected via a network to a vehicle provided with a vehicle sensor and a control circuitry, thus performing route prediction for the vehicle.
